(19) United States
(12) Patent Application Publication
(10) Pub. No.: US 2011/0120496 A1
(43) Pub. Date: May 26, 2011

(54) Automatic solvent reclamation system

(76) Inventor: T. Yomi Obidi, Melrose Park, IL (US)

(21) Appl. No.: 12/592,272

(22) Filed: Nov. 23, 2009

(51) Int. Cl. B08B 3/04

(52) U.S. Cl. 134/10; 134/104.1

(57) ABSTRACT

A closed loop solvent reclamation system designed such that liquid waste or solvent contained in a receptacle within or near a cleaning apparatus is drawn into a distillation chamber and the desired solvent is evaporated into a clean container, from which the solvent can be used again as a clean solvent. The entire process is automated, thereby ensuring the safety of the operator from solvent spillage at any point in the reclamation process. The design is compact, thus eliminating multiplicity of parts and includes a safety component such as a normal to flow, normally open thermostat, which ensures that the operator is not inadvertently exposed to hot solvent in the event of the failure of the heat exchanger, the latter being used to cool the reclaimed solvent for imminent use. In a further embodiment, a system disposed to separate and recycle solutions or compounds comprising multiple differing types of solvent.

### FIELD OF INVENTION

The instant invention relates generally to the fields of waste management and industrial chemistry. In particular, the instant invention relates to solvent reclamation and to the process of a just-in-time recycled solvent delivery system, which can be utilized for many industrial solvent systems.

### BACKGROUND OF INVENTION

Presently, product recycling is at the core of all fields of waste management. While careful engineering and management methods help to reduce the volume of raw materials used to produce an item or to provide a service, there is clearly a limit to the material reduction that can be effected while still providing the desired result. A greater environmental benefit is realized in the longevity of the product, the recyclability of the components after the product's primary life, and, in the case of service materials such as solvents, the recyclability of the materials utilized.

In the waste management field that addresses solvent recycling, industry standard mechanical equipments are employed to distil solvents. Solvent distillation essentially uses the significant difference in the boiling points between solvents and waste (with the solvent usually having the higher boiling point) to separate the solvent from the waste, thereby making the former available for re-use or recycle. Recycled solvents can help tremendously to reduce the volume of new (or virgin) solvents that would have otherwise been manufactured.

Thus, some of the disadvantages of existing products and methods include the constraint of gun cleaners to a specific recycler, therefore subjecting one to the pricing imposed by the manufacturer of the recycler, as the latter is the only one designed to fit the given gun cleaner. Additionally, there exist spray gun cleaners for which there are no corresponding/respective recycling systems. Furthermore, the intermediate equipment utilized in prior designs, such as a docking station or a specially made condensation can, is often cumbersome and cost prohibitive. Finally, the lack of existence of any fully automated or automatic units is also prohibitive to proper system operation.

Because of the significance of recycled solvents in view of waste management and environmental improvement purposes, the mechanics of recycling and the design of the components used in the recycling process are of significance. In the state of the art, generally waste is carried from its waste-creation location to a remote distillation station for renewal.

### SUMMARY OF THE INVENTION

The present invention facilitates the maximization of industrial solvent usage prior to complete breakdown of chemical properties and usefulness. The present invention can be utilized for automating the integration of an arbitrary paint spray gun cleaner to an arbitrary solvent recycler. Typically, solvent recyclers are designed to dock to particular gun cleaners, or other such apparatuses. The intermediate stages between the gun cleaner and the recycler are cumbersome, and are, at most semi-automatic in function. In the instant invention, any gun cleaner can be docked to any recycler with the modification or elimination of intermediate components.

Thus, the instant invention comprises the integration of an arbitrary gun cleaner with an arbitrary recycler and the full automation of the integrated unit. Furthermore, the instant invention features the optimization of the process by the introduction of compact air-cooled heat exchanger and the reduction of the turn-around time between the delivery of dirty solvent for recycle to the availability of recycled solvent for use.

The instant invention overcomes the disadvantages first by existing independent of the prior solvent recycler and gun cleaner designs, and thus independent of any potential constraints by the manufacturer of both or of either. Additionally the instant invention frees customer to source paint spray gun cleaners and recyclers independently. And, intermediate components, such as a docking station or a specially made condensation can, are in the essence eliminated by the instant invention.

Thus, the instant invention introduces a fully automated recycling system, which is highly desirable in an establishment that would possess the system as a “black box”. Further, the fundamental engineering principles involved in the instant invention comprise (i) system optimization; (ii) Automation; and, (iii) Convective heat transfer and the introduces the air-cooled heat exchanger.

The instant system also encapsulates an automatic solvent reclamation process is designed to comprise the waste collection and re-circulation unit, the distillation unit, and the recycled solvent collection and delivery unit, all connected to function in a system without human exposure to the solvent at any time in the reclamation process.

It is an object of the instant invention to introduce a recycling and waste management system.

It is another object of the present invention is to provide an on site alternative recycling method for solvent.

It is another object of the instant invention to introduce a multi-component, internally disposed system that maximizes solvent usage and extends solvent life.

It is another object of the instant invention to introduce a solvent fully automated reclamation system.

It is another object of the instant invention both to provide a fully automatic recycling process for used solvent and to introduce a direct and compact method to use the recycled solvent. Thus, the instant invention as illustrated herein is clearly not anticipated, rendered obvious, or even present in any of the prior art mechanisms, either alone or in any combination thereof.

It is another object of the instant invention to introduce a system wherein a solution of multiple differing solvents may be recycled.

There has thus been outlined, rather broadly, the more important features of the boot in order that the detailed description thereof that follows may be better understand, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Advantages of the present invention will be apparent from the following detailed description of exemplary embodiments thereof, which description should be considered in conjunction with the accompanying drawing, in which:

FIG. 1 is a schematic view of the solvent reclamation system illustrating the various components of the system.

### DETAILED DESCRIPTION OF THE INVENTION

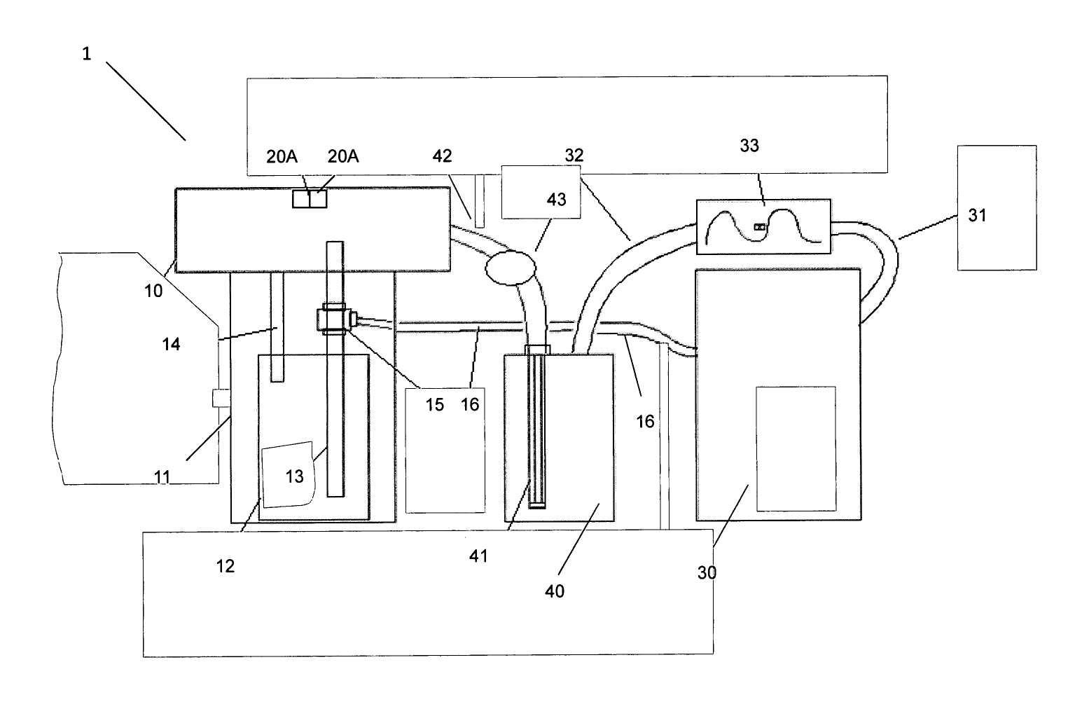

The instant invention both provides a fully automated recycling process for used solvent, and direct and compact method to use the recycled solvent. FIG. 1 illustrates the overall system 1 and the constituent parts thereof. At the star of the process, the dirty solvent can 12 contains clean solvent, which is pumped or sucked up through the dirty solvent suction pump 13 via a flow valve or flow diverter 15 to come into the parts washer bowl basin or containment chamber 10 through one of the solvent spouts at 20A and 20B. The parts washer bowl, basin or containment chamber 10 rests on its stand 11, the same having been designed to partially or fully enclose the dirty solvent can 12. The operator uses the solvent as it comes from the dirty solvent spout 20B and the solvent returns by gravity through the dirty solvent disposal hose 14 to the dirty solvent can 12. After several uses of the solvent coming from the dirty solvent can 12 it becomes necessary to recycle it. At this point, the 3-way valve or dirty solvent flow diverter 15 diverts the dirty solvent flow to the distillation unit 30 through the flow path for dirty solvent 16, a hose qualified to carry such solvent.

With the introduction of the 3-way valve or dirty solvent flow diverter 15, the instant invention eliminates the need for a separate, replacement can for the dirty solvent. In existing systems, the user was forced to remove the dirty solvent can, and manually carry it to dispose of it into a disposal or even to a remote distillation unit. In any of the concurrent inventions, the process required two separate containment systems, until the introduction of the instant automated system comprising the 3-way valve/dirty solvent flow diverter 15. Thus, the utilization of the 3-way valve/dirty solvent flow diverter 15 creates a compact sub-system.

During operation, the distillation unit 30 is heated to a preset temperature to allow for the evaporation of the desired solvent while the residue of paint and/or other materials remain in the chamber. This residue is collected and disposed of as required by law after it as cooled in the distillation chamber. Before this invention, the evaporated solvent was simply sent through a high-temperature hose 31 to the recycled solvent can 40 where it is either water cooled or allowed to cool by natural convection. In additional embodiments, a water-cooling tower or chamber may be integrated into the distillation unit 30 so that cooled, recycled solvent is obtained. Existing designs that incorporate a water tower or chamber are cumbersome and relatively wasteful of space, material, and coolant/water.

In this new design, the evaporated solvent is passed through a heat exchanger (L) to cool solvent to an acceptable temperature for imminent use. The cooled solvent is then transferred to the recycled/clean solvent can 40 through a hose 42.

Prior to the instant design, the clean solvent can was either manually moved to the operator's site for use or had its content transferred to another can, the latter having been designed to accommodate the pump to transfer the solvent to the clean solvent spout 20A as needed. This design eliminates both the need to move the clean solvent can or to add another can. The clean solvent can 40 houses a suction pump 41 that sends the fluid to the clean solvent spout 20A as needed through the hose 42.

Additionally, thermostat, designed with a setting of a normal to flow, normally open thermostat, known as the Obidi type 2 thermostat 43 is situated in the hose 42 before the solvent reaches the spout 20A. This is a safety device to prevent the continuation of the flow of hot solvent into the spout H, in the event that the heat exchanger 33 fails. Because it takes several hours to complete a batch, and because the cooling cycle is inevitable even if the distillation process is terminated it only makes sense, and is by far preferable to allow the distillation to continue even if the heat exchanger fails as long as a restriction is in place so that the operator cannot directly use the hot solvent. Therefore, the introduction of the normal to flow, normally open thermostat 43 is to date the most efficient way to ensure a minimum and safe, thus optimum turn-around time even in the event of the failure of the heat-exchanger.

In a further embodiment, a system disposed to separate and recycle solutions, mixtures or compounds comprising multiple differing types of solvents is disclosed. In said system, the differing fluids may be separated by methods known in the art and multiple solvent separator changes may take place outside of the distillation unit and at multiple hoses carrying the vapor phase of the solvent form the distillation chamber may be employed. Additionally, depending on the different heating levels needed for vaporization and phase change, multiple heat exchangers may be utilized.

In theory, the system may operate to process the multi-fluid/solvent mixture, by utilizing a fluid separation apparatus to separate and store the differing fluids entrained within the solvent mixture. Next by determining, for each fluid intended to be recycled within the mixture, the temperature range for processing, the individual fluids may be sent to differing distillation units in a distillation unit farm. Thus, the distillation unit may also be redesigned to possess multiple (3, 4, 5, depending on the # of fluids) ports.

In such configuration, each port will require two thermostats; the first, disposed closer to the distillation chamber designed to be normally closed, and the second, disposed closer to each heat-exchanger designed to be normally open. The normally closed thermostat should be set to open at the lower end of the particular fluid's temperature range, and the normally open should be set to close at the upper end. The upper end, if not specified for a given fluid, is, by default, the lower end temperature of the next (i.e. temperature-wise) fluid. To ensure minimal mixing for fluids with some temperature overlap, temperature of the distillation chamber should be controlled to be held substantially equal close to the lower end of a targeted temperature range for a verified length of time—the same principle used in thermal stress relief. Thus, in one embodiment of the instant design, each fluid goes through its own heat exchanger and can be delivered in a cooled, usable state, to its (labeled) container.

What is claimed is:

1. A solvent reclamation system comprising:
a parts washer apparatus comprising:
a containment chamber;
a support mechanism;
a dirty solvent containment apparatus;
a dirty solvent disposal hose in communication with said containment chamber and in communication with said dirty solvent containment apparatus disposed to transport solvent from said containment chamber said dirty solvent containment apparatus;
a dirty solvent suction pump system comprising:
a series of dirty solvent piping disposed to provide a flowpath;
a dirty solvent pump;
a dirty solvent flow diverter mechanism disposed within said series of dirty solvent piping, and designed to route used solvent for to a distillation unit;
a manifold comprising a plurality of solvent spouts;
a flow path for dirty solvent to be distilled in said distillation unit;
a clean/recycled solvent containment apparatus;
a hose carrying vapor phase of solvent from distillation chamber;
a heat exchanger to cool solvent to acceptable temperature for imminent use;
a first recycled solvent transport and delivery system disposed to carry a liquid phase of solvent to said clean/recycled solvent containment apparatus;
a recycled solvent suction pump disposed within said clean/recycled solvent can;
a second recycled solvent delivery system in communication with said manifold;
a control safety mechanism disposed for interruption of flow upon failure of said heat exchanger; and,
a safety device disposed for preventing the continuation of the flow of solvent into said manifold;
wherein said series of dirty solvent piping is disposed to route a quantity of solvent to said manifold until said dirty solvent flow diverter mechanism senses said quantity of solvent is too contaminated for usage; wherein upon sensing said quantity is too contaminated for usage, said dirty solvent flow diverter mechanism routes said quantity of dirty solvent to said distillation unit and wherein said distilling unit recycles said quantity of dirty solvent to create a quantity of recycled solvent, wherein said quantity of recycled solvent from said distillation unit is delivered to said recycled solvent containment apparatus via said first recycled solvent transport and delivery system; and wherein said recycled solvent suction pump delivers recycled to said manifold via said solvent recycled solvent transport and delivery system.

2. The solvent reclamation system of claim 1 wherein a first of said plurality of spouts is disposed for clean and recycled solvent.

3. The solvent reclamation system of claim 1 wherein an individual of said plurality of spouts is disposed to dispense re-circulated, dirty solvent.

4. The solvent reclamation system of claim 1 wherein said safety device comprises an inline thermostat mechanism.

5. The solvent reclamation system of claim 4 wherein said safety device is actuated upon failure of said heat exchanger.

6. The solvent reclamation system of claim 4 wherein said safety device is actuated when said recycled solvent reaches a preset high temperature.

7. The solvent reclamation system of claim 4 wherein said safety device comprises a normal to flow, normally open thermostat.

8. The solvent reclamation system of claim 4 wherein said system is further disposed to separate and recycle solutions comprising multiple different types of solvent.

9. A closed loop, automated solvent reclamation process comprising:
a cleaning unit;
a waste collection unit;
a re-circulation unit;
a distillation unit comprising an air-cooled heat exchanger;
a recycled solvent collection unit; and,
a recycled solvent delivery unit, wherein said waste collection unit is in fluid communication with said re-circulation unit, wherein said recirculation unit is in fluid communication with said distillation unit, wherein said recycled solvent collection unit and said recycled solvent delivery unit are in fluid communication with said distillation unit and cleaning unit via said re-circulation unit and wherein said recirculation unit provides recycled solvent to said cleaning unit.
